(19) United States
(12) Patent Application Publication
(10) Pub. No.: US 2006/0228692 A1
(43) Pub. Date: Oct. 12, 2006

(54) Method and apparatus for effectively capturing a traditionally delivered classroom or a presentation and making it available for review over the Internet using remote production control

(75) Inventor: Prasad Seshadri, San Jose, CA (US)

Correspondence Address: Fernandez & Associates, LLP, PO Box D, Menlo Park, CA, 94025-6204, US

(73) Assignee: Panda Computer Services, Inc., San Jose, CA (US)

(21) Appl. No.: 11/171,825

(22) Filed: Jun. 29, 2005

Related U.S. Application Data
(60) Provisional application No. 60/584,396, filed on Jun. 30, 2004.
(60) Provisional application No. 60/584,457, filed on Jun. 30, 2004.
(60) Provisional application No. 60/584,112, filed on Jun. 30, 2004.

(51) Int. Cl. G09B 25/00

(52) U.S. Cl. 434/365

(57) ABSTRACT

Systems and methods are provided to record classroom instruction with high production values, using networks and operators provided by the university, corporation, or other customer. Operators need not be trained video professionals and can operate from other locations on the campus. Instructors and students are not required to change any practices already existing in unrecorded classes. Two or more video cameras are deployed in the classroom, one assigned to the instructor and others assigned to the audience or students. The instructor wears a wireless microphone, and in some embodiments, an emitter of positional information. In some embodiments, two receivers of the positional information enable the instructor video camera to follow the instructor automatically. Video and audio signals are sent over a network to an operator computer, where the operator provides intelligent cuts between the various video cameras, monitors audio levels, and manually controls the video and audio devices in the classroom, the result being a level of production values heretofore unavailable without resort to an expensive setup with highly trained, in-class video professionals.

### CROSS-REFERENCE TO RELATED APPLICATION

This patent application is a conversion of U.S. provisional applications Ser. No. 60/584,396, filed Jun. 30, 2004; pending; Ser. No. 60/584,457, filed Jun. 30, 2004, pending; and Ser. No. 60/584,112, filed Jun. 30, 2004, pending; the priority dates of which are claimed and the disclosures of which are incorporated by reference.

### BACKGROUND

1. Field of the Invention

Instructional content generated by university personnel as well as organizational wisdom created by professionals in organizations are either being lost to posterity or not being harnessed to their full potential, since the content disappears and is preserved imperfectly only in the minds of a few. One of the greatest challenges in introducing technology into classroom or a presentation context is resistance to technology on the part of a traditional instructor, who must focus on instruction and the students rather than be distracted by presentation technology issues, which do not represent his/her core interest or objective, and is therefore unwilling to make the adjustments or compromises necessary to adapt to technology

### SUMMARY

The invention aims to create a viable platform and methodology to be able to routinely and effectively capture instructional content and make it available with minimum delay to remotely located personnel as well as for future audiences.

The invention includes a methodology of optimizing the capture of good video quality with remote video production methodology, attempting to capture all the action in a traditional live instructor based classroom or a presentation. The invention aims to ensure that the recording of the classroom does not require the instructor to substantially deviate from the delivery method he is accustomed to and yet capture all the typical elements of classroom instruction. Additionally, the instructor is not required to operate any equipment other than the ones he is currently accustomed to, or none at all, if he does not wish to.

### BRIEF DESCRIPTION OF THE DRAWINGS

FIG. 1 is a diagram illustrating the classroom ensemble which allows effective capture of a classroom or presentation.

FIG. 2a is a diagram illustrating prior art in the area of the invention.

FIG. 2b is a diagram illustrating the classroom setup in the invention.

FIG. 3 is a diagram illustrating data flow in the invention.

FIG. 4 is a diagram illustrating the controller user interface for the audio mixer of the invention.

FIG. 5 is a diagram illustrating the portion of the operator user interface for controlling audio signals.

FIG. 6a is a diagram illustrating a plan view of the instructor camera with two detectors, and the rotary base and stepper motor.

FIG. 6b is a diagram illustrating an elevation view of the instructor camera with two detectors, and the rotary base and stepper motor.

FIG. 7 is a diagram illustrating the portion of the operator user interface for controlling video signals.

FIG. 8 is a diagram illustrating software-based motion estimation.

FIG. 9 is a flowchart illustrating the instructor's actions in teaching a class.

FIG. 10 is a flowchart illustrating the operator's actions in recording a class.

FIG. 11 is a flowchart illustrating the automatic tracking method of the instructor video camera based on detectors mounted on the camera.

FIG. 12 is a diagram illustrating the Internet Controlled Mixer.

### DETAILED DESCRIPTION

The term “server”, when used here, is broadly understood to mean any computing entity or family of such entities capable of responding to user requests over a network. The computing entities may be computer servers or server farms, general purpose digital computers, personal digital assistants, special-purpose devices such as printers or scanners with digital processors built in, or specialized hardware devices such as XML chips or XML computers; either containing storage units or making use of storage units elsewhere on the network. The family of computing entities may be geographically distributed or may be “virtual” entities within a larger entity.

The term “video signal,” when used here, is broadly understood to mean a digital represenation of a video signal. It can be lossy or lossless, and can include any suitable format, including CCIR 601, MPEG-1, MPEG-2, MPEG-4, H.261, H.263, H.264, any codec-based, MiniDV, Digital8, DVD, or other formats already existing or yet to be invented.

The term “video camera”, when used here, is broadly understood to mean a device for recording electronic moving images, and optionally, sound. It can include a professional video camera, studio camera, camcorder such as those sold for consumer and hobbyist use, webcam, closed-circuit television camera such as those used in surveillance, or any device capable of capturing video information. It can capture the video in analog or digital form. The digital signal can be any form of video signal according to the previous definition.

The term “audio signal”, when used here, is broadly understood to mean any digital representation of an audio waveform. It can be lossy or lossless, and can include WAV, PCM, TTA, FLAC, AU, MP3, Ogg Vorbis, Windows Media Audio, TTA, RIFF, AIFF, IFF, BWF, Advanced Audio Coding, or other format already existing or yet to be invented.

The term “microphone”, when used here, is broadly understood to mean a device that converts sound into an electronic signal, whether a digital signal or an analog signal. It can include a capacitor, electret, dynamic, ribbon, carbon, or a piezo microphone, a lavalier microphone such as the kind often clipped to a speaker's clothing for active, hands-free use, or other. The digital signal can be any form of audio signal according to the previous definition.

The term “user interface control”, when used here, is broadly understood to mean any suitable hardware or software permitting a human being to provide input to a computer. Hardware devices include joysticks, styluses, mice or other pointing devices, keyboards, touch screens, keypads, microphones and other computer peripherals already existing or yet to be invented. Software includes typed commands, hyperlinks, graphical user interface controls such as menus, buttons, choice lists, check boxes, radio buttons, and the like, already existing or yet to be invented. Software user interface controls can be provided via a command-line interface, graphical user interface, Web-based interface, gestural interface, tactile interface, or other.

The term “classroom,” when used here, is broadly understood to mean a physical setting comprising one or more rooms in which one or more persons (“the instructor”) deliver information to one or more audience members. It can include a classroom in any K-12 school, college, graduate school, training institute, corporate training center, hospital, military base, research institute, conference center, or other instructional setting, or a conference room in any for-profit, governmental or non-profit organization.

The term “PTZ,” when used here, is broadly understood to mean pan, tilt, and zoom, three well known terms of art with respect to all cameras.

The term “detector” when used here, is intended to be synonymous with the term “sensor” in the provisional applications of which this application is a conversion.

The term “emitter” when used here, is intended to be synonymous with the term “transmitter” in the provisional applications of which this application is a conversion.

In the prior art, some universities and training institutions adopt several methodologies to deliver distance learning content to remotely located students. Most of them are text and graphics based or delivered through CD-ROM or video tapes. The disadvantage of all these methods is that they are labor intensive as well as requiring a time consuming effort to transfer educational content to these media. In addition, the recorded content is fixed and cannot be kept current easily.

The true gold standard for educational content delivery is the traditional way of delivery-which is by a live instructor teaching in a class to students physically located in a classroom, using a whiteboard and other educational aids like a computer and a projector for doing slide presentations. A common goal, then, is to capture this traditional form of delivery and all its elements and record it in electronic media for instant or nearly instantaneous remote delivery. In order to achieve this, many methods have been attempted in the prior art:
a) Video recording by a live production crew with a classroom. The disadvantage of this is that it is expensive to deploy such a crew and this is also an obtrusive presence in the class which can be distracting.
b) Live attendance of traditional classes have been transmitted over controlled media like ATM networks, Intranets etc. They are referred to as video- teleconferencing networks. These yield a good quality of picture-but the problem is that the remote student has still to travel to a place where there is connectivity to this network. This limits the remote student population that can be served and limits the proliferation of this concept. Also an important element of distance learning is the ability of the student to achieve self paced learning. Having to be at a given place at a given time reduces the utility of this approach.
c) Yet others have achieved recording of live lectures and a degree of automation by limiting the movement of the instructor and modifying the method of content delivery by eliminating the whiteboard completely and instead using pre-composed slides which can be more effectively transmitted over the internet after being recorded. This extends ability to reach more paying student population since the transmission is over the internet and the remote student can take the class from wherever there is internet connection. The problem with this approach is that changing the method of delivery of instruction limits its potential for adoption. Also, seeing the instructor practically immobile and unable to walk about reduces him to a virtual talking head, thereby subtracting from the richness of the in-person delivery

In light of the foregoing, there exists a need in the art to achieve the following goals:
a) The instructor must be able to move around the classroom without restriction. He should not be constrained to having to be within the restrictive field of view of the camera(s).
b) The student-instructor interaction must be captured and recorded with clarity.
c) Whiteboard/blackboard activity must be recorded without restriction on the size or color of the whiteboard/blackboard or restriction on the size of the instructor's handwriting or the type of material he uses for writing.
d) The instructor must be able to continue using existing tools like slide projectors or other instructional equipment currently in use, and images and/or audio from these must be captured effectively.
e) Most importantly, this system must not introduce any additional technology overhead on the instructor. Many instructors in fields like humanities and social sciences are so technology-averse that they use the most traditional means of instruction-with the teaching material being restricted only to chalk and blackboard or a whiteboard and marker. There is a need in the art for a solution for such instructors as well.
f) It must not be necessary for every in-class student to be attached to a computer, nor must they be required to carry individual microphones. It must not be necessary to have individual cameras for every in-class student, nor may the in-class student be required to press any button before he/she interacts with the instructor. In other words, it must be like any traditional class.

Capturing classroom activity with good production values has the following advantages:
a) Having a recorded class as opposed to a live on-line class appears prima-facie to be an inferior choice but there are good reasons why it turns out to be the preferred choice. On-line students typically use the on-line option for reasons of convenience. A major factor in the choice is typically the inability to commit themselves to being at a certain place at a certain time. In addition, the option to avail of self-paced study and the ability to take a class any time and anywhere is a major convenience. These are typically features of asynchronous learning which have historically proven to be more popular than synchronous learning, which requires attendance at the time the class is being conducted. In globally distributed organizations, staff that needs to peruse the content may be at different time zones from where the live presentation is made. This makes live attendance even more awkward to achieve. Asynchronous attendance from recordings is distinctly advantageous even in the context of these organizations.
b) The ability to record classes reliably, inexpensively and with good production values increases the asset base of the university or organizations that collect the content since they can use this asset base to generate additional income as in the case of universities or to train their new staff from archived material. Currently, in-person traditional classes and development of content for on-line offering are separate activities-and they are a wasteful duplication of effort. Productivity almost doubles if the two can be combined with a single content delivery - the traditional delivery, which, being the de facto standard mode of delivery in universities, can never be eliminated. All this makes this methodology of content capture a valuable weapon to generate a better and more substantial economic remuneration to universities for their intellectual capital or source of cost savings for other types of organizations.

The invention as described herein meets the aforementioned goals.

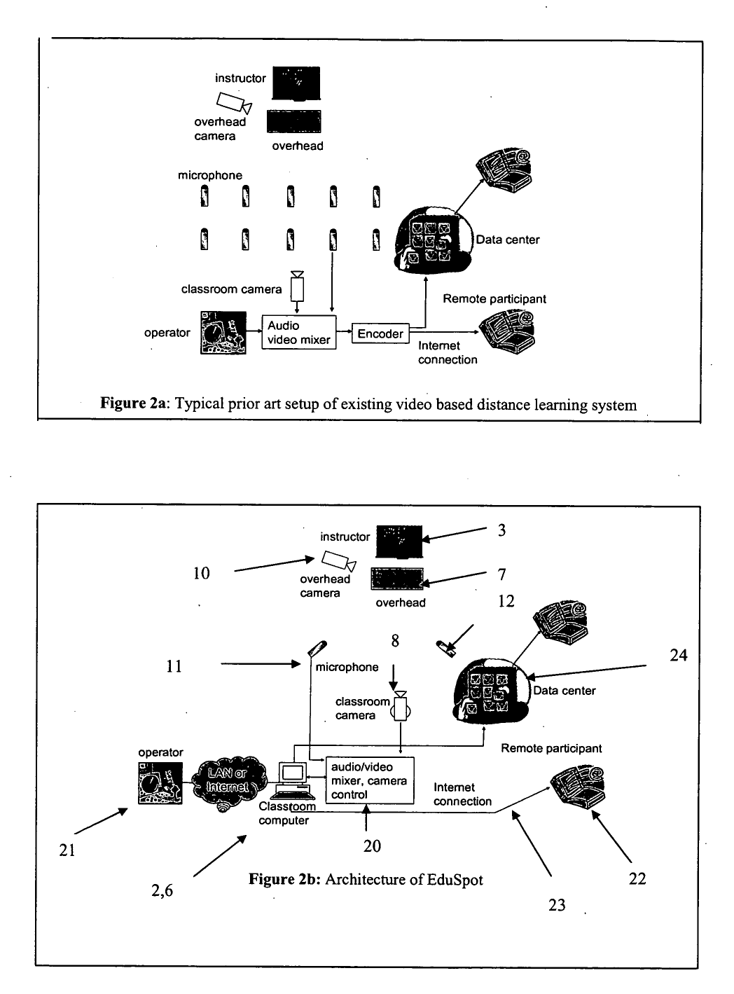

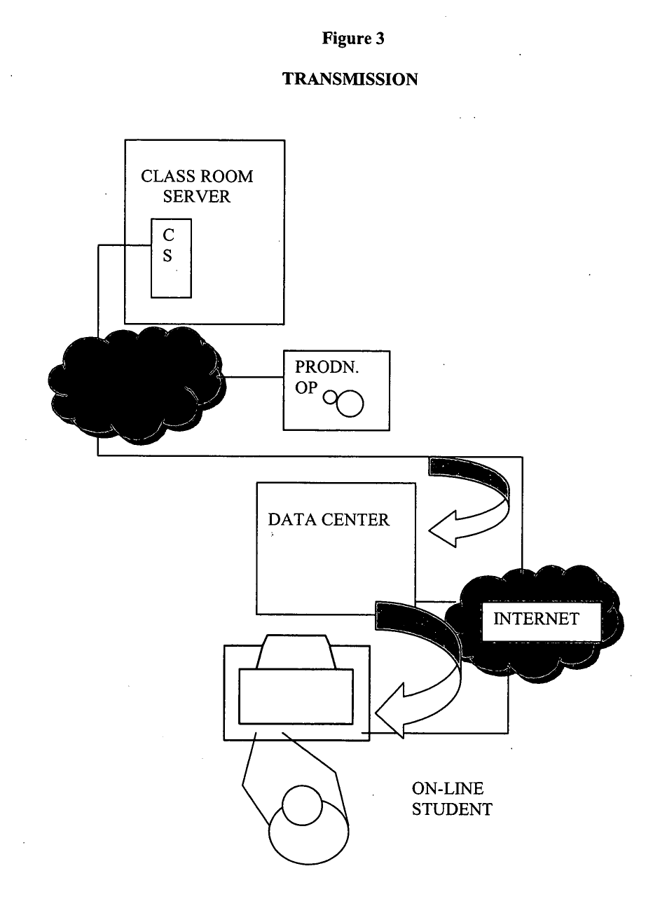

FIG. 2a illustrates a prior art setup for recording classroom instruction with an in-class production operator.

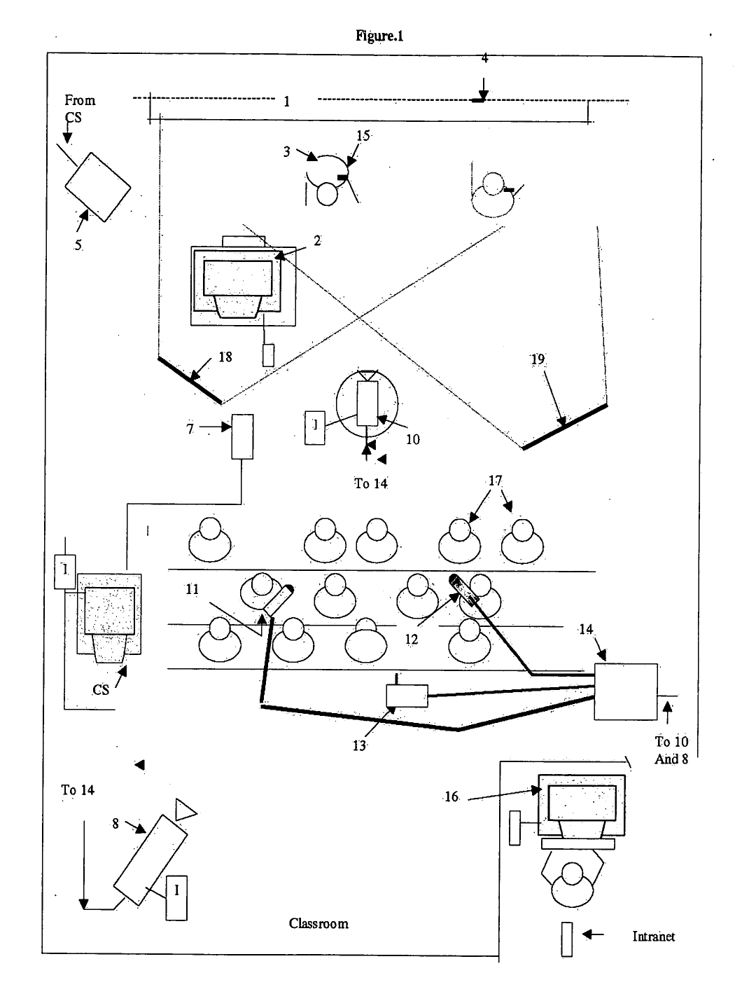

FIG. 2b and FIG. 1 illustrate a system of the invention.
1 is a whiteboard or blackboard at the front of the class.
2 is an instructor PC, used for lecture notes, PowerPoint slides, etc.
3 is the instructor.
4 is a whiteboard/blackboard activity sensor.
5 is a television monitor used to signal messages to the instructor from the operator or other personnel outside the classroom.
6 is a classroom server, providing control of classroom components, routing of audio and video streams, temporary storage of content, and other functionality.
7 is an overhead projector for use by the instructor.
8 is an audience video camera, to occasionally see an audience member or an attendee. There can be a plurality of such units. Each such unit is separately network-addressable.
10 is a pan/tilt/zoom (PTZ) instructor camera for tracking the instructor, whiteboard/blackboard activity, and other activity at the front of the class. The instructor camera is separately network-addressable.

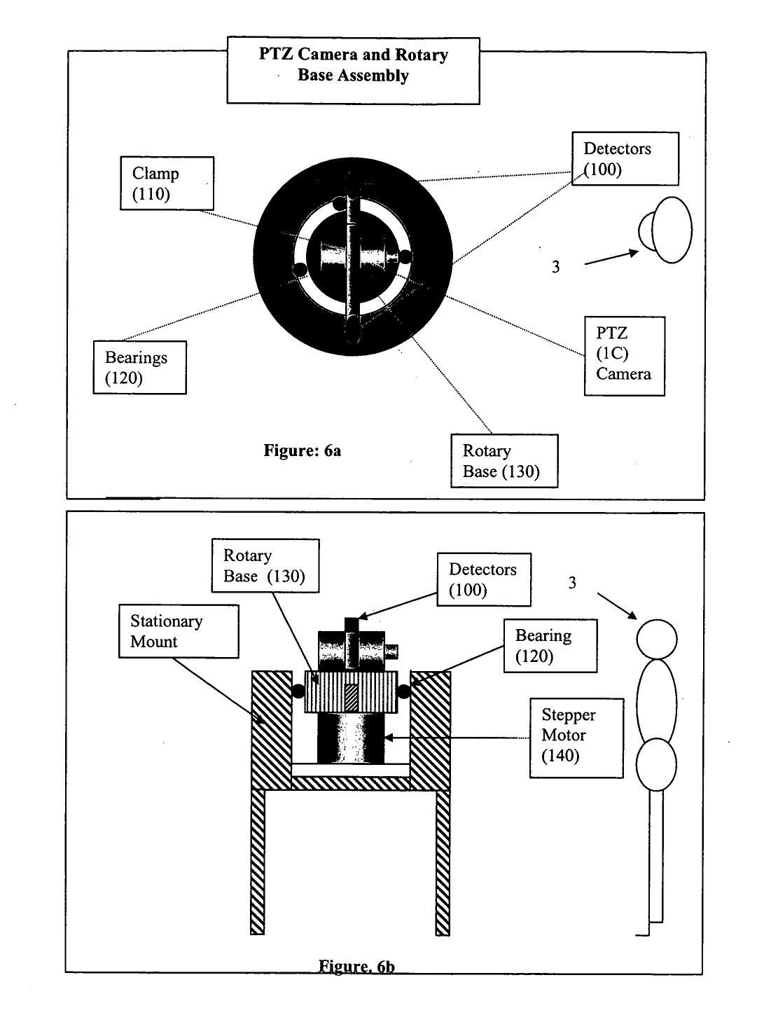

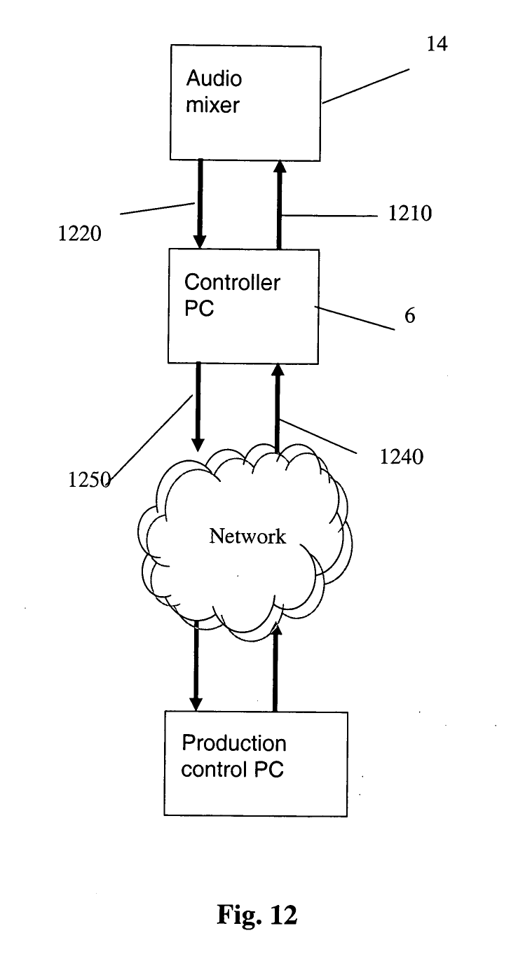

In one embodiment, the instructor camera 10 is part of a larger assembly, shown in FIGS. 6a and 6b.
11 and 12 represent one or more omni-directional microphones to pick up audience audio. The microphones, if more than one are present, point to different directions of the class, covering the entire classroom. The student microphones 11 and 12 are directional units with a parabolic reflector/concentrator mounted on the ceiling pointing downwards in various directions providing coverage over the entire classroom. The microphones pointing to the further reaches of the classroom have longer reaching and more directional characteristics like the hyper cardioid microphones and those looking directly downwards are less directional with a larger spread like cardioid microphones
13 is an audio receiver for a wireless microphone worn by the instructor.
14 is a mixer, to control and mix audio from different microphones. Mixer 14 is part of a larger assembly, shown in more detail in FIG. 12.
15 is a wireless microphone and positioning signal emitter for positioning, worn by the instructor. In one embodiment, 15 represents two separate devices, a microphone and an emitter, where the microphone is clipped to the instructor's shirt, tie, or other article of clothing, and the emitter is worn on the shoulder, so that transmissions are not blocked when the instructor turns his/her back.

The emitter, in one embodiment, emits infra-red signals. In one embodiment, an emitter of infrared at a peak wavelength of 940 nm may be used. A suitable device is marketed by Kodenshi with manufacturer's part number OPE5794. The emitter requires a power supply, electronics for amplification, and compensation for deterioration of the signal with age of the emitter. In other embodiments, an emitter of any suitable form of electromagnetic radiation such as RF signals, or ultrasonics, or any other form of signal capable of being received wirelessly at a distance, may also be used.
16 is an operator computer connected via a network to the classroom system.
18 and 19 are lights with dimmers that can be controlled electronically.
20 is a video server providing video input selection and recording.
21 is a human operator, possibly remote and connected via a network. The operator can be located anywhere but preferably reasonably close to the classroom location so that the control signals do not get delayed excessively.
22 is a remote participant in the class, connnected via a network 23.

The datacenter 24 is at a central location with respect to all the locations where classrooms are being captured. This location gets data feeds from all the classroom servers 6 and this is the location where content management takes place and from where streaming servers feed the captured classroom sessions to the remotely located students 22. One or more servers 25 at datacenter 24 perform a modularization step on the captured audio and video signals, described below.

The remote students 22 have computers connected to the network with a broadband connection providing a high data rate. The streaming can be achieved through any firewalls that might be in place on these computers.

All the student microphones, for example 11 and 12, feed into audio mixer 14 which detects and enhances the dominant student audio channel while switching off the others, and mixes it with the audio signal from instructor microphone 15. The output of the mixer 14 is fed simulaneously into all the video cameras which have the ability to mix the audio and video signals to generate a composite encoded audio/video signal. The encoded composite audio/video outputs are fed to the video server 20 for selection and recording.

### AUDIO CAPTURE

In capturing classroom instruction, audio capture is the most important element, more important than video. Even if a few interruptions occur in the video or a few video frames are lost, the instruction does not lose its thread, but the audio must be perfect. The audio content has two components in the classroom context: the instructor audio and the student audio. Of the two, the instructor audio has the higher priority and therefore a dedicated microphone 15 is assigned to the instructor.

The distance between the microphones 11 and 12, and a specific student speaking varies, as do the voices of different students speaking, as well as the ability of the microphone to best pick up the student who is speaking. The microphone sensing the strongest signal is boosted to the required level automatically by the mixer 14 and the other microphones 11 and 12 are switched off to avoid any phase cancellation effect. This type of operation is known as automatic mixing. Commercially available automatic mixers, such as the SCM810 8-channel mixer from Shure, can be used as 14 to perform this function. Such commercial mixers also have the ability to emit a signal of a constant frequency, in one embodiment 1 KHz, to serve as a reference for a human operator. This signal, if present, is displayed on a user interface screen at 460.

A separate hardware and software system is operative to control the mixer 14 in response to commands set over the network. Collectively the system in FIG. 12 is called the Internet Controlled Mixer. A controller PC, in one embodiment the classroom server 6, emits control signals 1210 to 14 via an A/D converter, and receives status signals 1220 from 14 via another AID converter. The controller PC receives digital control signals 1240 from the operator computer over the network, and emits status signals 1250 to the operator computer over the network.

### VIDEO CAPTURE

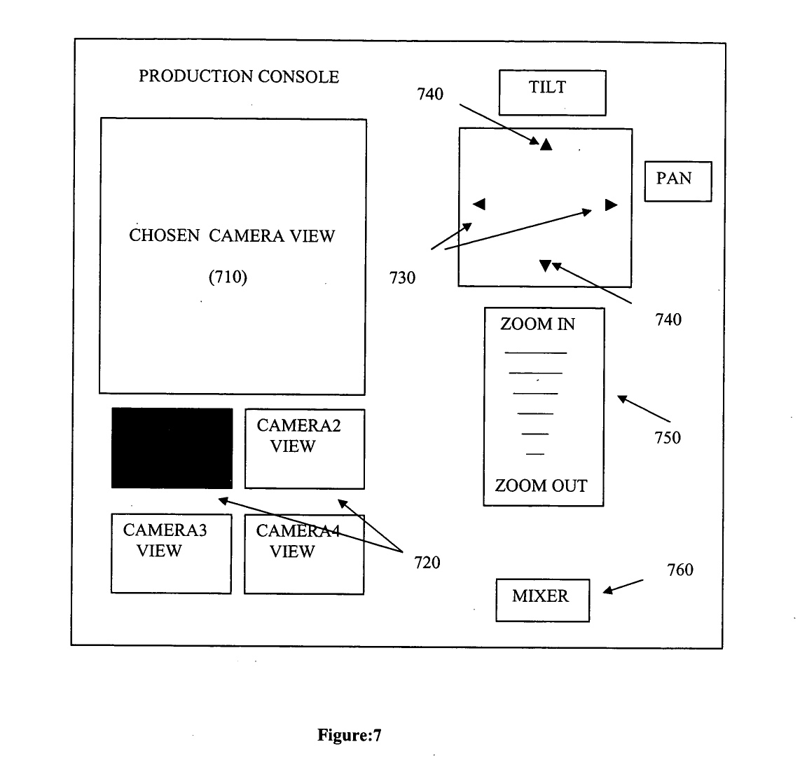

The Internet controlled PTZ cameras 8 and 10 are placed facing different parts of the classroom. In a simple configuration, 2 such cameras suffice, while in some embodiments more audience cameras are deployed. PTZ cameras are capable of Panning, Tilting and Zooming based on commands from remotely located operator 21, who operates these cameras using the user interface depicted in FIG. 7.

FIGS. 6a and 6b illustrate the special features on the PTZ camera 10 facing the instructor. The camera assembly 10 is placed on a rotary platform 130 which is mounted on a stepper motor shaft 140. Two infrared detectors 100 are placed laterally across the camera, equidistant from the vertical axis - the line joining the detector is perpendicular to this axis. These detectors 100 detect the signal from the emitter 15 on the instructor's person.

In one embodiment, infrared detectors of a peak wavelength of 940 nm may be used as 100. A suitable detector is available commercially from Kodenshi with manufacturer's part number KP307R2. The detectors require a power supply and electronics for amplification. In other embodiments, any suitable detector capable of receiving the positioning signals emitted by 15 may be used.

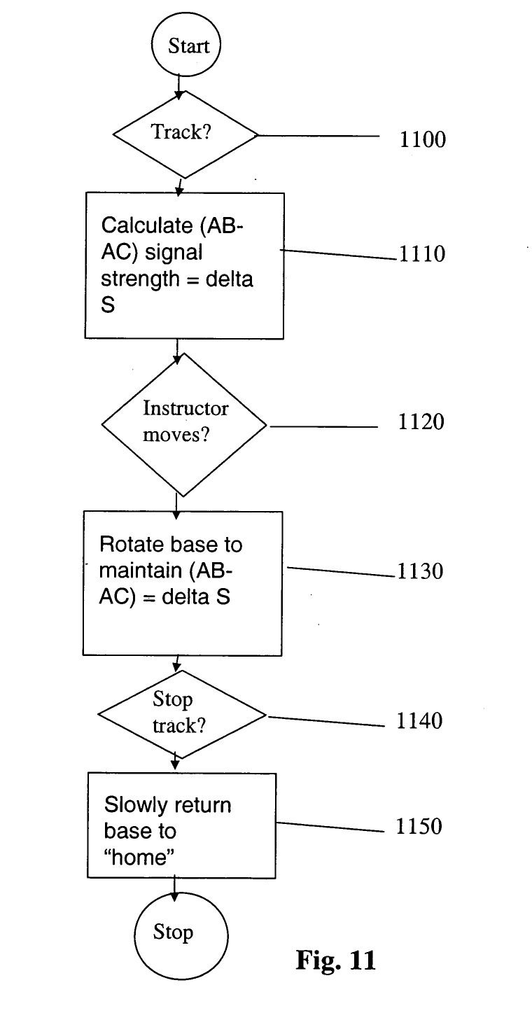

The difference between the strengths of the signal perceived by the detectors 100 at the moment the operator 21 requests automatic tracking becomes the frame of reference. Automatic tracking is achieved by a dedicated software program configured on the classroom server 6, moving the stepper motor in the following manner illustrated in FIG. 11:

The program checks, at 1100, whether automatic tracking has been requested. If so, the program computes, at 1110, the absolute value of the difference S1 in the strengths of the signals measured by the first detector and the second detector. At 1120, the absolute value of the difference D is again computed, and if D is greater than S1, the instructor is considered to have moved. If the instructor has not moved, the algorithm moves back to step 1110. If the instructor has moved, at 1130 the base 130 is rotated towards the side of the camera 10 on which the detector whose strength is greater is mounted, until the original difference in strength is restored. Automatic tracking continues in this manner. If the operator now selects manual tracking, the algorithm rotates the base 130 to a “home” position.

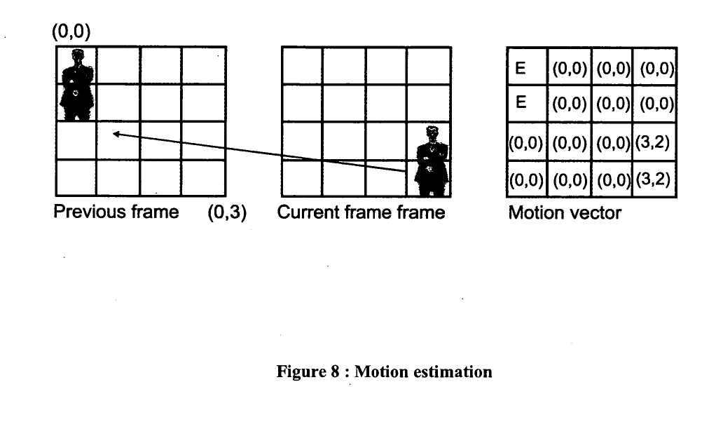

Other methods of automatic tracking of a moving object without using an emitter mounted on the object are well-known in the art, namely motion detection, as illustrated in FIG. 8. In other embodiments, the invention can utilize one of these methods to cause the camera 10 to track the instructor 3.

FIG. 7 illustrates the operator user interface running on operator computer 16. The video signals of the instructor camera 10 and the student cameras 8 are all sent to the operator user interface. Rectangle 710, which displays the video signal from the camera chosen to be recorded, and 720, which depict video signals from all cameras, are thumbnail images which are kept small in size to keep bandwidth requirements to the minimum. The production operator 21 can view images 710 and 720 to determine which image will be of interest to the remote viewer. Clicking on one of the images 720 selects the video signal to be sent for recording, and changes thumbnail image 710 to the selected video signal.

Each camera also has an input for the processed audio from the audio mixer 14. The cameras combine the video and audio signals to yield composite video/audios signals, before the composite signal is sent to the classroom server 6 for temporary storage.

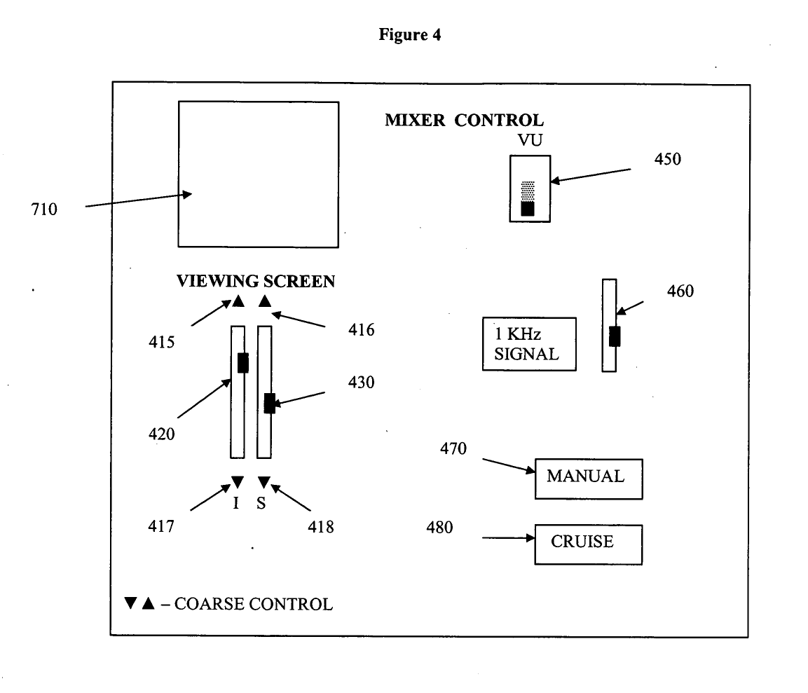

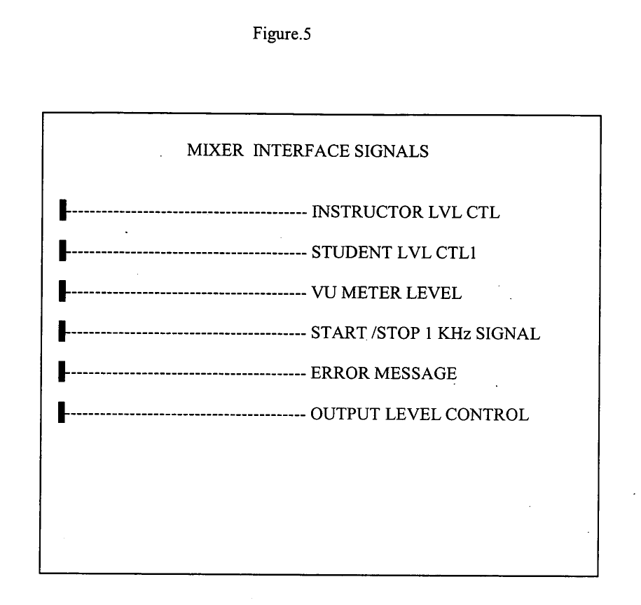

Repeated switching between the views 720 provide “cuts”, a term of art in film production, to the video stream, which enhances the production values of the stored content as well as providing coverage of events by context. This sort of cutting is difficult or impossible to automate, and thus requires a human operator. The ability to capture events by human judgment adds great value to the quality of the captured content. 760 invokes the user interface displays illustrated on FIG. 4 and explained below.

The user interface controls 730, 740, and 750 provide the operator 21 with the ability to manually pan (730), tilt (740) and zoom (750) the instructor camera 10. User interface controls 470 and 480 provide the operator 21 with the ability to invoke either manual or automatic tracking of the instructor by camera 10.

User interface control 760 invokes the display illustrated in FIG. 4 for audio controls. On the operator audio user interface screen shown in FIG. 4, 710 displays the currently-selected video signal, 420 and 430 display the current levels of the audio signals from the instructor's microphone 15 and the mixed output of the student microphones 11 and 12 from the Internet Controlled Mixer. Controls 415 and 417 permit the operator 21 to send signals to the Internet Controlled Mixer to raise or lower, respectively, the level of the audio signal from the instructor microphone 15, and controls 416 and 418 permit the operator 21 to send signals to the Internet Controlled Mixer to raise or lower, respectively, the level of the audio signal from the mixed output of the student microphones 11 and 12 to the mixer 14. The raising and lowering operations thus invoked take place before the mixer 14 mixes the instructor microphone and the selected audience microphone.

450 is a VU meter displaying the overall level of the audio being recorded.

### SYSTEM INTERACTIONS

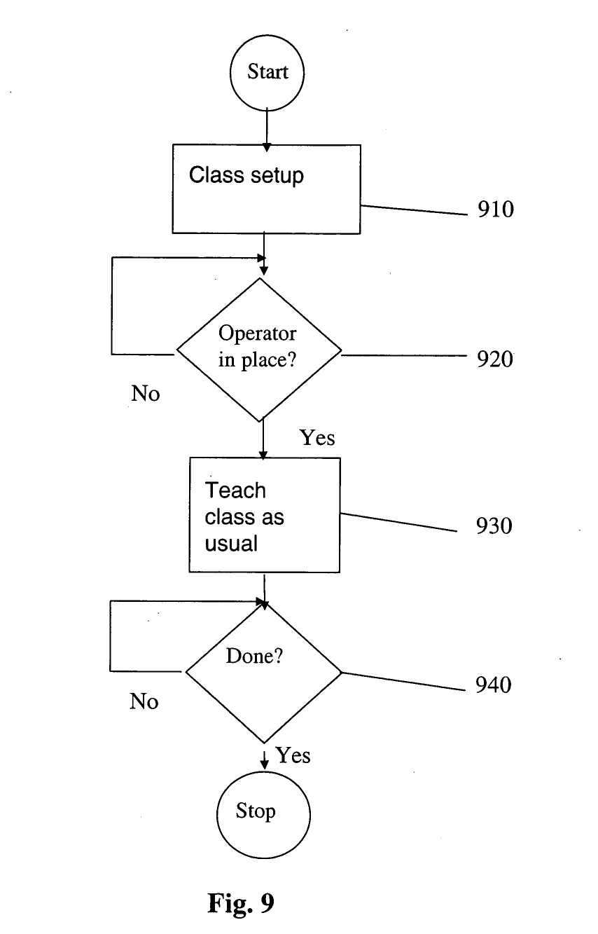

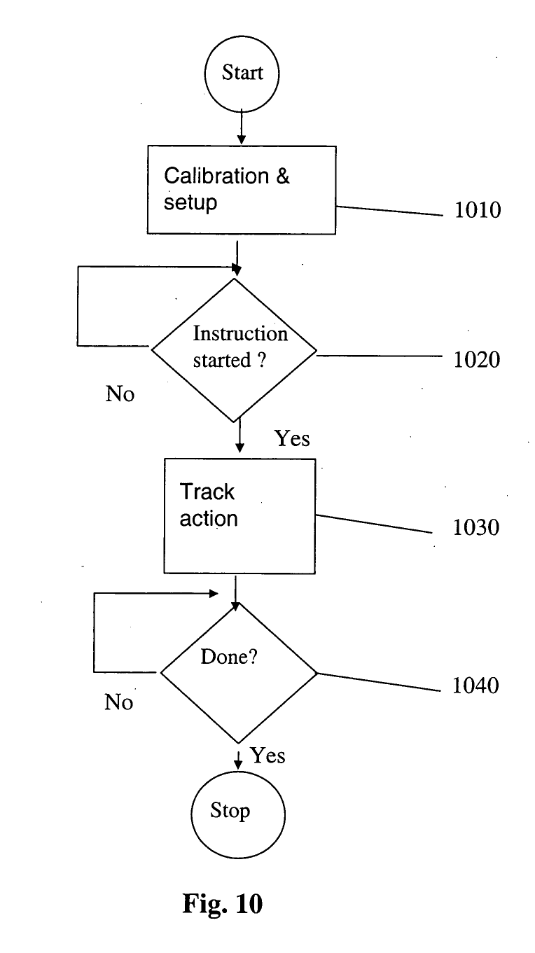

FIG. 9 depicts the flow chart of the instructor 3's interaction with the system and FIG. 10 shows how the operator 21 interacts with the system . .

At 910, the instructor 3 enters the room and uses the instructor computer 2 to set up the classroom by entering details like course information, lecture number and course title. Instructor 3 also types and speaks one or more keywords representing the main themes of the lecture. This signals to the remote operator 21 that the instruction is about to start. The remote operator 21 checks the video camera images, checks that switching operation is working and the audio from the instructor microphone 15 is also working. The operator then acknowledges ‘all ok’ to the instructor 3 via television monitor 5 signaling to him that the classroom instruction can be delivered.

The remote operator 21 selects a view 720 and starts the recording process. He looks at the VU meter 450 on his UI to check if the instructor audio is at the level required for recording. If it is not, he boosts the gain or attenuates using the controls 415 and 417 on his screen and brings it to the required 0 db level. If a student speaks to ask a question or respond to the instructor, the operator selects via 720 the camera trained on the students and using user interface control 750, zooms in on the student. His eye is now glued to the VU meter 450 to ensure that the student audio is at the right level-if not, he uses the student audio user interface controls 416 and 418 to bring it to the required level even as the student is speaking.

While the camera 10 trained on the instructor is selected, the operator 21 might choose the CRUISE mode 480 to try and minimize his having to intervene manually in the production process. When the camera is put on the CRUISE mode, the currently-installed automatic tracking system is selected. If the operator 21 intervenes and manually tries to operate the camera movement via user interface controls 730, 740, or 750, the system reverts to the manual mode and returns control to the operator till CRUISE mode is again requested.

When the operator 21 selects the video signal from instructor camera 10 to send for recording, the student cameras 8 are all zoomed back to wide angle position so that the thumb nail views 720 show more panoramic views of the class from their standpoint rather that a zoomed in view. This enables the operator to see the entire view of the class from various angles so that he can determine where the point of interest in the class lies. If it were to remain trained zoomed in on only a portion of a class or a student, then any interesting action in the vicinity might be missed.

The operator continues in this manner till the entire class is recorded and stops the recording process once the instructor stops the delivery.

### BUSINESS METHODS

In one embodiment, the business method of the invention, for providing recording of classroom instruction to an organization, includes using a network owned by the organization and/or operated on behalf of the organization to connect the operator 21 to the classroom setup. Such an network, referred to as an intranet, infranet, or campus network, is often found on college and some K-12 campuses, as well in corporations and other institutions, and can often provide a much shorter network round trip time than the public Internet. Such shorter delays are helpful to the invention, since they minimize the delay between the operator noticing a need to respond to a change in classroom conditions, and the time at which the operator's commands are executed in the classroom. A delay of 50 milliseonds or less has been found advantageous in one embodiment of the invention.

In one embodiment, the business method of the invention involves using students or employees of the organization as the operators, rather than providing highly trained audio-video professionals. In a campus scenario, inexpensive student labor is available, and such employment is beneficial to the student as well, since the job is available conveniently within the confines of the campus, enabling an additional supplemental income to be earned during the spare time at their disposal, and preferably from wherever they are located. It is also helpful if they can execute the responsibility from any terminal or computer connected to the campus intranet or even from their home over the public internet, provided that network delays are acceptable. Similarly, administrative staff is available in organizations; where presentations are made by technical as well as managerial staff that need to be perused by remotely located employees.

### MODULARIZATION

A typical college class can range from one hour to several hours, while corporate and other institutional classes can be much longer. While a high-quality recording of such a class is a valuable service in itself, the service can be enhanced significantly by breaking up the class into modules, based on a natural division into topics covered. Such modules can be posted to a public area of a web site, for example, providing an advertisement for the complete course, and in some cases, they can provide a service of their own (for example, a course on plumbing could be advertised by the module on fixing a leaky toilet). There is therefore a need for a practical way of auto-detecting the natural division into topics of a classroom session.

However, speech recognition is a very difficult problem, especially for continuous speech, and usually requires either a controlled vocabulary, or speaker training, or both. The same business factors are at work in this area as those mentioned earlier; neither a fully-automated system nor extensive, skilled human labor are economically practical, and a novel method of doing business is required. Such a method is provided in the invention.

As mentioned earlier in the section on system interactions, at the start of a lecture, the instructor types and speaks a series of keywords into a microphone connected to classroom computer 2. The audio signals for the spoken keywords, as well as the typed keywords, are forwarded through classroom server 8 and over the network to a server 25 at datacenter 24. The audio signals for the spoken keywords serve as “speaker training” for the voice recognition software in use on 25.

After the audio signals are stored at 25, the files containing the audio signals are searched for occurrences of each keyword via voice analysis software. For this purpose, commercially available voice recognition software can be used as a component of the voice analysis software, such as the Dragon Naturally Speaking product from ScanSoft, in one embodiment. Any commercial or custom software with an acceptable error rate (90% or better) can also be used for this purpose, such as IBM's ViaVoice, L&H Voice Xpress Plus, Philips FreeSpeech98, and others.

The recorded audio signals are also analyzed to detect pauses in the instructor's speech, and the time codes for such pauses are recorded. Any reasonable period of no speech by the instructor can be interpreted as a pause; in one embodiment, 3 or more seconds has been found usable. The beginning of the instruction period and the end of the instruction period are also considered pauses. The period between two pauses is defined as a “module”, if the following definition of keyword frequency is met:

When a given keyword is used more than a specified number N of times within a specified period P1 . . P2 of length T, a discussion of the topic defined by the keyword is considered to have occurred by the module definition software. A module is then defined as the time from the last pause before the period P1 to the next pause after P2. In one embodiment, T is 5 minutes and N is 3. Other values are possible in other embodiments of the invention. The term “voice analysis software” when used here, is broadly understood to mean, collectively, the commercially available recognition software together with such configuration and additional software as is required to realize the complete keyword recognition, pause detection, and module definition functionality described above.

The complete recorded instruction is thus indexed, via indexing software, according to all module definitions and their associated keywords. This enables the voice recognition software referred to earlier to split out modules into separate files, which are then hyperlinked into promotional or other web pages according to the policies of the customer.

The aforementioned business methods for delivering the recording of instruction are enhanced by this modularization feature. Students, for example, can randomly access topics of interest, as opposed to having to sequence through an entire lecture to find the topic of interest. Also, such modules extracted from university lectures can be used to generate income from corporations for the owners of the content-the university, in one instance. Such modules can be used to illustrate topics on corporate web sites. For example, if a university professor talks on the topic ‘Beta Blockers’, it would be advantageous for the manufacturers of beta blocking drugs to hyperlink references to ‘Beta-Blockers’ on their site so that if a visitor to the site clicked on the word ‘Beta-Blocker’ he will be able to listen to a prominent authority on the subject talk about it. Another advantage of the business method of the invention is the ability of the customer to provide the human touch of seeing and hearing another human being explain ideas and concepts. Listeners are informed of the name of the instructor and the institution where he/she teaches, bringing additional exposure to these entities and inviting viewers to sign up for courses, thereby driving up enrollment at these institutions.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

What is claimed is:

1. A system for recording classroom instruction, comprising:
two or more video cameras in a classroom, at least a first camera assigned to an instructor and at least a second camera assigned to the audience, wherein the cameras are PTZ-controllable over a network;
an operator computer connected to the cameras via a network, the operator computer configured with user interface software comprising:
displays of the video signals from the cameras; and
user interface controls to permit cuts between the video signals from the cameras.

2. The system of claim 1, additionally comprising:
a classroom server operably connected to the video cameras, the classroom server configured with software operative to control the pan, tilt, and zoom of the cameras, wherein the classroom server is connected to the operator computer via the network; and
user interface controls to manually control the pan, tilt, and zoom of the one or more cameras.

3. The system of claim 2, wherein the user interface software additionally comprises:
user interface controls to invoke and cancel an automatic mode for tracking the instructor by the first camera.

4. The system of claim 3, additionally comprising:
at least two detectors, one detector mounted on each horizontal side of the first camera, the detectors operative to capture and measure the strength of a specified form of positioning signal;
a rotary platform mounted on a stepper motor shaft, the first camera being attached to the rotary platform, wherein the stepper motor is operably connected to the classroom server;
a emitter of a specified form of positioning signal, the emitter worn by the instructor;
wherein the automatic mode is a method comprising the steps of:
computing, repeatedly, the difference between the strengths of the positioning signal measured by the first detector and the second detector, and if the absolute value of the difference is greater than a specified amount, designating the side of the first camera wherein the detector whose measured strength is greater is mounted; and
causing the first camera to move horizontally to the designated side by a distance sufficient to reduce the absolute value of the difference to less than the specified amount.

5. The system of claim 4, wherein the specified form of positioning signal is infra-red at a peak wavelength of 940 nm.

6. The system of claim 5, wherein the specified amount is the amount measured at the time automatic tracking is requested.

7. The system of claim 6, additionally comprising:
an instructor microphone worn by the instructor;
one or more audience microphones so disposed as to pick up sound from the audience;
an audio mixer operably connected to the instructor microphone and the audience microphones, the mixer operative to select and boost the signal of the audience microphone whose signal is strongest, and to cut off the signal of other audience microphones, and to transmit the signals of the audience microphone whose signal is strongest, and the instructor microphone;
wherein the audio mixer is operably connected via the network to the operator computer, and wherein the user interface software additionally comprises:
user interface controls to allow the human operator to view the levels of the signals and listen to the signals; and
user interface controls to raise and lower the levels of the signals, and user interface controls to cause recording of the signals.

8. A system for controlling the recording of audio signals from classroom instruction, comprising:
an audio mixer for mixing the audio signals from two or more microphones and outputting a mixed audio signal, and outputting a separate reference signal;
means for inputting control signals to the mixer from a classroom server;
means for receiving audio output signals from the mixer into the classroom server;
means for transmitting the control signals and the audio output signals from the classroom server to an operator computer over a network;
means for displaying user interface controls on the operator computer, wherein a human operator can control the levels of the audio signals from the microphones, prior to the mixing of the audio signals by the mixer.

9. A method for controlling the recording of classroom instruction, comprising the steps of:
displaying, on a display screen coupled to an operator computer, video signals from one or more video cameras deployed in a classroom,
wherein the cameras are controllable via a network connected to the operator computer,
wherein a first camera is dedicated to the instructor, and
wherein at least one of the cameras is dedicated to the audience; and
displaying a user interface control on the operator computer, wherein a human operator can make cuts between the video signals from the cameras; and

10. The method of claim 9, additionally comprising:
displaying a user interface control on the operator computer, wherein the human operator can manually cause the first camera to perform one or more of pan, tilt, and zoom operations; and
displaying a user interface control on the operator computer wherein the human operator can invoke and cancel an automatic method to cause the first camera to perform one or more of pan, tilt, and zoom operations.

11. The method of claim 10, wherein the automatic method is a software-only method of motion tracking.

12. The method of claim 10, wherein the automatic method comprises the steps of:
invoking a method on a classroom server connected to the first camera, the method comprising the steps of:
computing, repeatedly, the difference in the strengths of a positioning signal measured by a first detector and a second detector, the detectors mounted on opposite sides of the first camera, and if the difference is greater than a specified amount, selecting a designated side of the first camera wherein the detector whose measured strength is greater is mounted; and
causing the first camera to move horizontally to the designated side by a distance sufficient to reduce the difference to less than the specified amount.

13. The method of claim 12, additionally comprising the steps of:
displaying a user interface control on the operator computer wherein the human operator can listen to the audio signals; and
displaying a user interface control on the operator computer wherein the human operator can modify the audio signals, and
displaying a user interface control on the operator computer wherein the human operator can cause recording of the audio signals.

14. A method of providing recording of classroom instruction to a customer, comprising the steps of:
deploying two or more video cameras in a classroom, at least a first camera assigned to an instructor and at least a second camera assigned to an audience, wherein the cameras are PTZ-controllable over a network, wherein the network is controlled by a customer, and wherein the classroom is controlled by a customer;
deploying an operator computer connected to the cameras via the network, wherein the operator computer is configured with user interface software comprising:
displays of the video signals from the cameras;
user interface controls to manually direct the pan, tilt, and zoom of one or more of the cameras;
user interface controls to permit cuts between the video signals from the cameras; and
utilizing a person acting in the employ of the customer as the operator of the operator computer.

15. The method of claim 14, additionally comprising the steps of:
deploying a datacenter server operably connected to the operator computer;
voice analysis software configured on the data center computer, comprising:
pause detection software, operative to detect a pause of a first length in the audio signal representing the instructor's speech;
keyword recognition software, operative to detect a keyword in the audio signal representing the instructor's speech; and
module definition software, operative to define a module as the period between a first pause and a second pause, wherein the keyword is detected at least a first count of times within a first interval, the first interval being entirely bounded by a first pause and a second pause.

16. The method of claim 15, additionally comprising:
indexing software operative to create an index of keywords and their modules within a recorded classroom instruction.

17. The method of claim 16, additionally comprising:
one or more remote servers;
file transfer software configured on the datacenter server, operative to transfer the recorded classroom instruction and the index to the remote servers.

18. The method of claim 17, wherein the first count is 3.

19. The method of claim 17, wherein the first interval is 5 minutes.

20. The method of claim 17, wherein the first length is 3 seconds.
